(19) United States
(12) Patent Application Publication
(10) Pub. No.: US 2007/0292115 A1
(43) Pub. Date: Dec. 20, 2007

(54) DVD palyer with function of displaying multinationaltext type of subtitles simultaneously

(75) Inventor: Chang Jen-Chi Yang, Taipei County (TW)

Correspondence Address: BACON & THOMAS, PLLC, 625 SLATERS LANE, FOURTH FLOOR, ALEXANDRIA, VA, 22314, US

(73) Assignee: Nuvofilms. Com, Inc, New Castle County, DE (US)

(21) Appl. No.: 11/808,031

(22) Filed: Jun. 6, 2007

(30) Foreign Application Priority Data
Jun. 14, 2006 (TW) 095210351

(51) Int. Cl. H04N 5/00

(52) U.S. Cl. 386/125

(57) ABSTRACT

The present invention is to provide a DVD player with function of displaying multinational text type of subtitle simultaneously. In the DVD player, the hidden DVD multi-national subtitle is transformed into the text type of subtitle essentially by a text type of subtitle generation module. The video and the multi-national text type of subtitles are merged by a video subtitle composing unit and then are transmitted to a video output device to display the multi-national text type of subtitle in the DVD video on time so as to provide both effects of the video watching and the language learning.

### BACKGROUND OF THE INVENTION

1. Field of the Invention

The present invention relates in general to a DVD player with function of displaying multinational text type of subtitles simultaneously. In particular, the present invention relates to a DVD player with function of displaying subtitles, in a text type mode, having more than one languages in the DVD video to enable the user to browse the displayed subtitles and to enable the displayed subtitles to serve to other usages.

2. Description of the Related Art

A prior art DVD player system was disclosed in the U.S. Pat. No. 5,907,658. In the disclosed DVD system, the digital data, after being read from a DVD disc into a buffer memory area, was separated into video stream, audio stream and sub-picture stream by the system resolution apparatus 2. Each stream, then, was transmitted to the MPEG video decoding unit 3, the audio decoding unit 4 and the sub-picture decoding unit 5, respectively. The results were transmitted to the audio output apparatus 6 by the audio decoding unit 4 to output digital audio signals. Hereinafter, the results were transmitted to the video/sub-picture composing unit 7. The sub-picture decoding unit 5 only decoded the sub-picture data in the pre-determined channels and then transmitted the results to the video/sub-picture composing unit 7. Through mixing by the video/sub-picture composing unit 7, the video were transmitted to the video output apparatus 8. However, such a DVD system allows the user to choose only one subtitle from the multiple subtitles to display. Further, during displaying, the subtitle can only show with a single sentence. Languages-comparison function is lacked in such a DVD system so that the users can not learn a foreign language by comparing different languages therefore. Therefore, a bilingual-style learning environment can not be created by such a DVD system to the users.

Referring to FIG. 3, another prior art DVD player system was described in the Taiwanese Patent No. 522,379. In this system, a character recognition unit 11 was added in the DVD player to recognize the subtitle picture from the sub-picture decoding unit and then transformed the subtitle picture into text code output on the screen. However, the so-described DVD player is one kind of hardware displaying device allowing only one type of subtitle to display at the same time. Moreover, neither the displayed sentences nor the un-displayed sentences are allowed to browse by the users. If a system intends to allow more than two types of sentences to display simultaneously, an additional subtitle database has to be established in a DVD disc. However, to establish an additional subtitle database in a DVD disc is not so frequently found in a traditional DVD video that the users who intend to perform bilingual education through such a DVD video are greatly limited in operating it. A student who intends to learn a foreign language by such a limited DVD display system can only achieve limited results.

### SUMMARY OF THE INVENTION

Accordingly, an object of the present invention is to provide DVD player with function of displaying multinational text type of subtitles simultaneously. In this DVD player, the hidden DVD multi-national subtitle is transformed into the text type of subtitle essentially by a text type of subtitle generation module. The video and the multi-national text type of subtitle are merged by a video subtitle composing unit and then are transmitted to a video output device. Furthermore, the displayed multi-national text type of subtitles are marked with their corresponding displaying timecode to benefit users in choosing the displayed text in the subtitle to serve as a start location for displaying video. Additionally, the subtitle with multi-national letters can be displayed in the DVD video at one time so as to provide both effects of the video watching and the language learning.

The present invention can be more fully understood by reading the subsequent detailed description and examples with references made to the accompanying drawings.

### DESCRIPTION OF THE DRAWINGS

FIG. 1 is a schematic view of a prior art DVD player system;

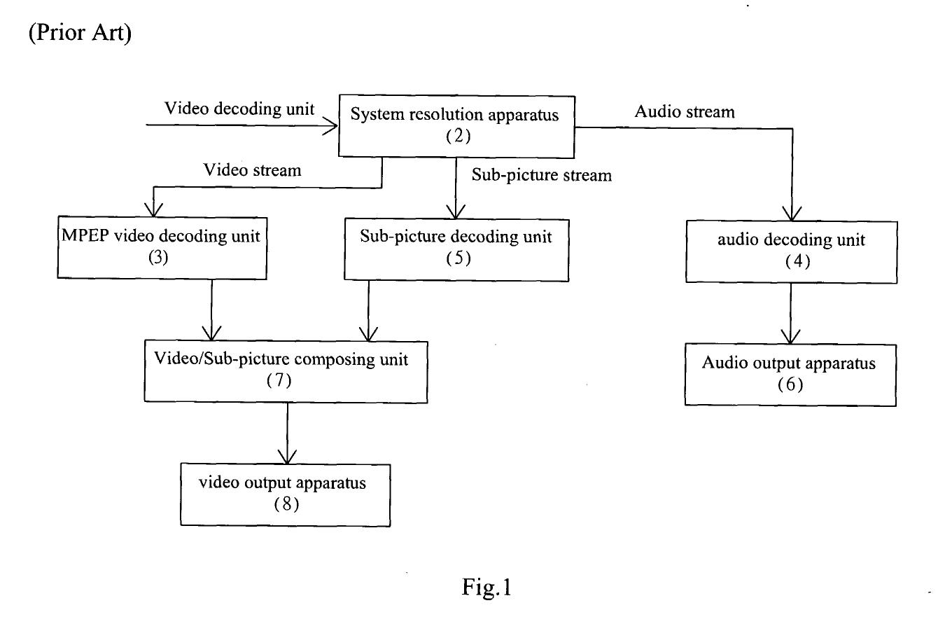

FIG. 2 is a schematic view of another prior art DVD player system;

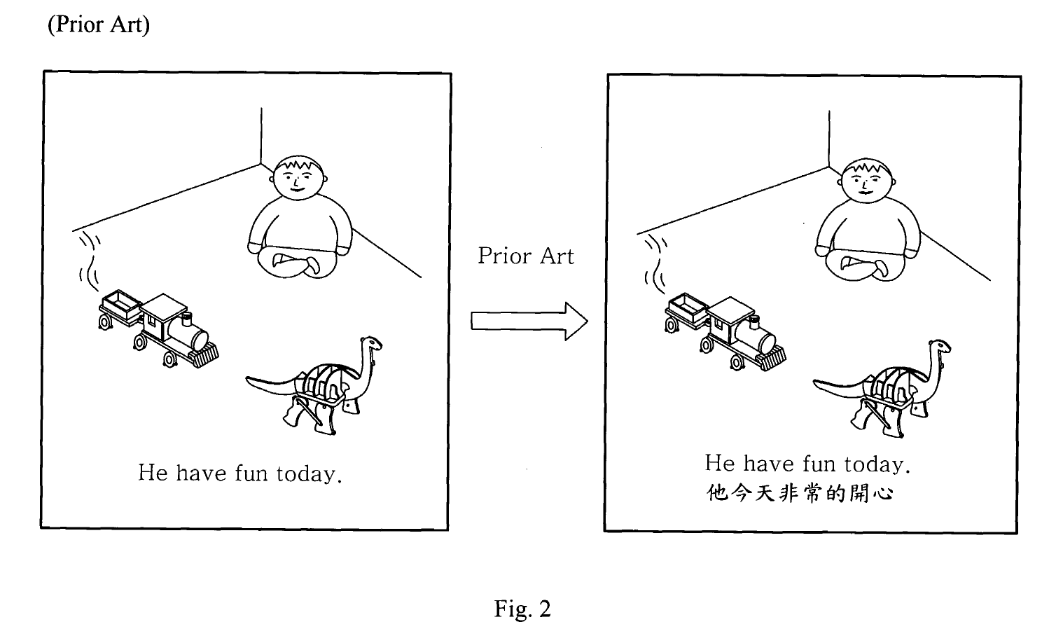

FIG. 3 is a schematic view of another prior art DVD player system;

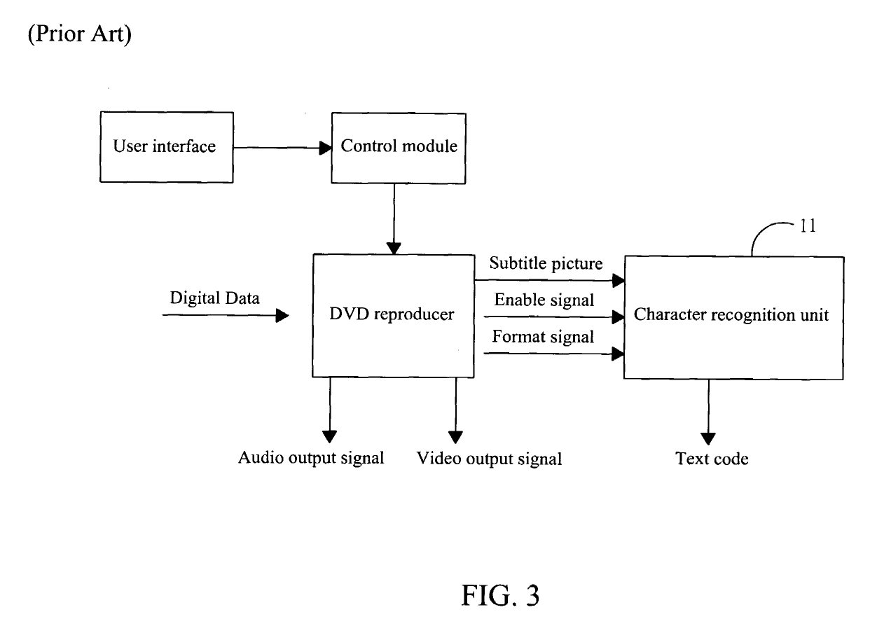

FIG. 4 is a schematic view of the structure of the DVD player according to the invention; and

FIG. 5 is a schematic view of the DVD player according to the invention during performing.

### DETAILED DESCRIPTION OF THE PREFERRED EMBODIMENT

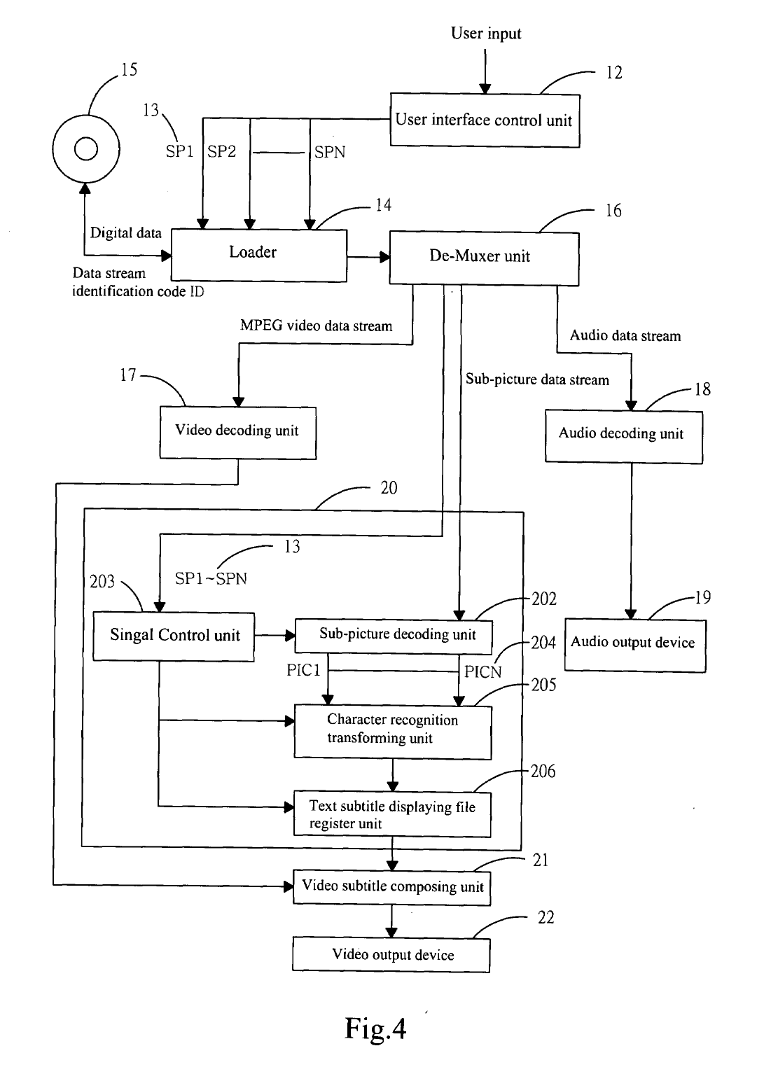

Referring to FIG. 4, the DVD player with function of displaying multinational text type of subtitles simultaneously according to the invention includes a user interface control unit 12. The user interface control unit 12 is provided to receive a multinational language option from a user. For example, if the user chooses the third and the fifth languages, the user interface control unit 12 will output SP3 and SP5 subpicture control signal to a loader 14. This loader 14 is provided to receive the multinational subpicture control signal 13 (for example, SP1, SP2, SP3 . . . , SPN) emitted from the user interface control unit 12, wherein SP1 is the subpicture control signal of the first type of subtitle, SP2 is the subpicture control signal of the second type of subtitle and so on. The device 14 reads both digital data and data identification code (ID) from a DVD disc 15, and then outputs both the data and the ID to a de-muxer unit 16. The de-muxer unit 16, according to data stream identification code ID, separates the digital data read from the DVD disc 15 into a MPEG video data stream, an audio data stream and a subpicture date stream. The MPEG video data stream is transmitted to the video decoding unit 17. The audio data stream is transmitted to the audio decoding unit 18. The subpicture data stream is transmitted to the subpicture decoding unit 202 of the text typed subtitle generation module 20. The multi-language type of subpicture control signals 13 (SP1, SP2 . . . , and SPN) are loaded into the signal control unit 203 of the text typed subtitle generation module 20 by the de-muxer unit 16.

The text typed subtitle generation module 20 is provided to produce a displaying file of the subtitle with multi-national texts. The module 20 includes a subpicture decoding unit 22 provided to decode the multi-national subpicture data stream in DVD video 15 into multi-national picture type of subtitle 204 (PIC 1, PIC2 . . . PICN). The signal control unit 203 of the text typed subtitle generation module 20, according to the multi-national subpicture control signal 13 (SPI, SP2 . . . SPN) received from the de-muxer unit 16, sequentially sends variable enable signal to the sub-picture decoding unit 202. When the sub-picture decoding unit 202 receives the enable signal, the sub-picture data stream is submitted to decode by the unit 202. After decoding, multi-national picture type of subtitles 204 (PIC 1, PIC 2 . . . PICN) are acquired. The multi-national picture type of subtitle 204 (PIC 1, PIC 2 . . . PICN) are transmitted to a character recognition transforming unit 205 of the text typed subtitle generation module 20. The character recognition transforming unit 205 is provide to receive the multi-national sub-picture control signal 13 (SP1, SP2 . . . SPN) from the signal control unit 203, and then sequentially performs a character recognition transformation onto the multi-national picture type of subtitle 204 (PIC 1, PIC 2 . . . PICN). Each of the multi-national sub-picture control signals 13 (SP1, SP2 . . . SPN) represents a sub-picture control signal of one country, (for example, SP1 is English, SP2 is traditional Chinese and SP3 is Japanese) so that the character recognition transformation unit 205 will load a language database (for example, English, Chinese and Japanese) according to its corresponding multi-national sub-picture control signal 13 (SP1, SP2 . . . SPN). Thus, the picture type of subtitle is transformed into its corresponding text type of subtitle facilitating to establish a text type of subtitle displaying file. In this case, the character recognition transformation is a traditional tech of optical character recognition (OCR). The OCR function can be called to perform either by a built-in mode or a built-out mode. When the character recognition transformation unit 204 receives the multi-national sub-picture control signal 13 (SP1, SP2 . . . SPN) from the signal control unit 203, it will, according to the context of the enable signal, transmits each multi-national picture type of subtitle 204 (PIC 1, PIC 2 . . . PICN) to its corresponding OCR software from each provider to produce a text type of subtitle and subtitle displaying timecode. The so-produced subtitle and timecode then is transmitted to a text subtitle displaying file register unit 206. The text subtitle displaying register unit 206 receives the enable signal from the control unit 203. Then, the unit 206 composes the text type of subtitle and the subtitle displaying timecode from the character recognition transforming unit 205 into a text subtitle displaying file 206 and stores the file 206. After all text subtitle displaying files are completed, the control unit 203 emits an enable signal of complete. When the text subtitle displaying file register 206 receives the complete enable signal, all text subtitle displaying files altogether are sent to a vide subtitle composing unit 21. In this case, the timecode of the displaying text subtitle is the time at which the text shows off and the duration period for which the text sustains displaying The timecode is provided to inform the DVD player when and which sentence has to display for how long a period of time. The signal control unit 203 is received in the de-muxer unit 20 and has one input end to connect with an output end of the de-muxer unit 20. The signal control unit 203 essentially receives the multi-national sub-picture control signal 13 (SP1, SP2 . . . SPN) from the user interface control unit 12 and then transmits the received signal to the sub-picture decoding unit 202, the character recognition transforming unit 205 and the text subtitle displaying file register unit 206. A video decoding unit 17 has an input end connected with the output end of the de-muxer unit 16. The video decoding unit 17 decodes the video data stream received from the input end and then outputs the decoded video data to the video subtitle composing unit 21.

An audio decoding unit 18 has an input end connected with the output end of the de-muxer 16. The audio decoding unit 18 decodes the audio data stream received from the input end and then outputs the decoded audio signal to an audio output device 19.

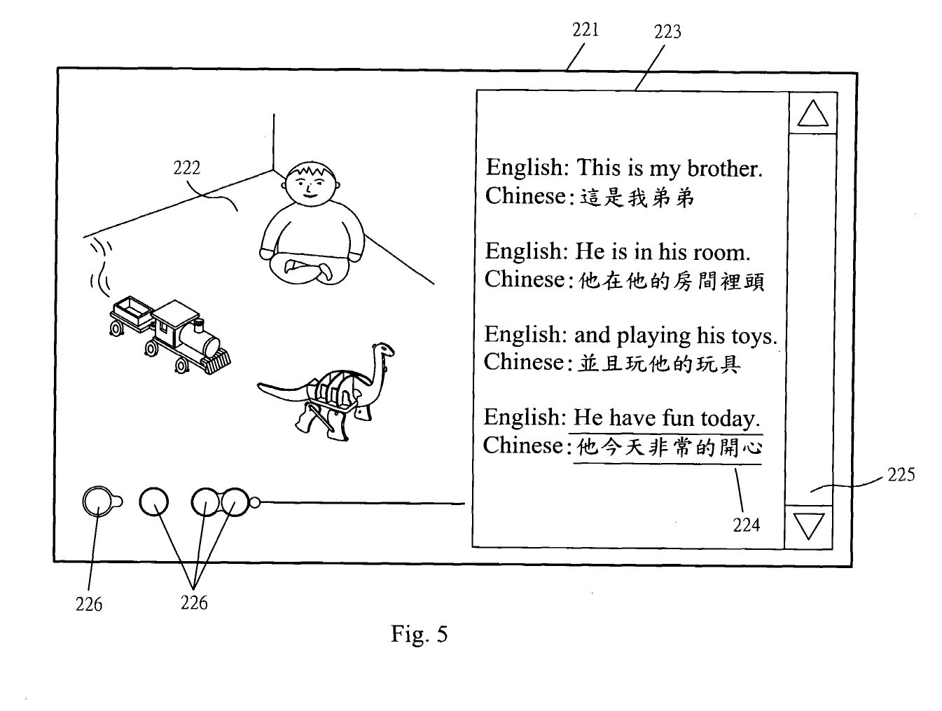

The video subtitle composing unit 21 connects with the video decoding unit 17 and the text typed subtitle generation module 20, respectively, to receive video data and text subtitle displaying file and composes and links them. After composing and linking, the unit 21 transmits the results (subtitle 223 with multi-national texts, see FIG. 5) to a video output device 22. During the video data stream and the subtitle display file are combined and linked by the video subtitle composing unit 21, a browsing area 165 wherein the users can browse the displayed sentences, and player function keys, such as a play key, a pause key, a stop key, a forward key and a backward key, are added in the video. At the same time, the sentences 224 showing in the subtitle can be marked to show off each of their corresponding displaying time and can serve as a starting location to start displaying the video. The video output device 22 has an input end connected with the output end of the video subtitle composing unit 21. The device 22 is used to display the video containing a subtitle having texts in variable languages so that the users can both watch the video and learn the languages.

Referring to FIG. 5, the video output device 22 is screen 221. Through the video subtitle composing unit 21, the video and the subtitle containing multi-national languages are combined and linked, and then are transmitted to the video output device 22 so as to show off a subtitle containing more than two languages of text type at one time on the DVD video. The displayed sentences are marked with each of their corresponding displaying time, respectively, so that the users are benefited to browse both the displayed sentences. The users further can choose a subtitle sentence to serve as a start location in order to start displaying the video. Thus, objects both of video watching and language learning are provided to the users. In the embodiment according to the invention shown in FIG. 5, through the DVD player with function of displaying subtitle with multi-national texts, the video 222 and the subtitle 223 can be simultaneously displayed on the screen 221. The displayed sentence 224 will be marked through combining and linking the video data and the subtitle displaying file by the video subtitle composing unit 21. The displayed sentences can be searched in the browsing area 225. In addition, functions, such as displayed sentence searching, vocabulary explaining and vocabulary pronunciation, can be performed in the browsing area 225. Displaying functions such as play, pause, forward, backward and so on in video 222 can be controlled by displaying function keys 226 so as to benefit the users in learning the conversations in the DVD video, and thus a bilingual learning is promoted. The users will feel more interested with respect to the bilingual learning and drawbacks found in prior art bilingual learning are resolved by using the DVD reproducer according to the invention.

### Comparison between the system according to the invention and the prior art system is made to distinguish the progress and utility of the invention in following.

Drawbacks in the Prior Art System
1. only displaying subtitles with one or two language by a single sentence;
2. unable to browse the displayed sentences on time;
3. unable to provide functions such as such as displayed sentence searching, vocabulary explaining and vocabulary pronunciation, and
4. unable to provide perfect multi-lingual learning.

Advantages in the System According to the Invention
1. capable of displaying a subtitle with more than two languages;
2. capable of browsing the displayed sentences on the video on time;
3. having functions such as such as displayed sentence searching, vocabulary explaining and vocabulary pronunciation, and
4. capable of providing a better multi-lingual education environment.
   Although the present invention has been particularly shown and described above with reference to the preferred embodiment, it is anticipated that alterations and modifications thereof will no doubt become apparent to those skilled in the art. It is therefore intended that the following claims be interpreted as covering all such alteration and modifications as fall within the true spirit and scope of the present invention.

What is claimed is:

1. A DVD player with function of displaying multinational text type of subtitles simultaneously comprising:
a user interface control unit provided to receive a multinational language option from a user and then to output a corresponding sub-picture control signal to a loader;
the loader provided to receive the multinational subpicture control signals from the user interface control unit, then, to read both digital data and data identification code (ID) from a DVD storing medium, and then to output both the data and the ID to a de-muxer unit;
the de-muxer unit having an input end connected with an output end of the loader and outputting digital data to input ends each of a video decoding device, an audio decoding unit and text type of subtitle generation module, meanwhile outputting multi-national sub-picture control signals to a signal control unit of the text type of subtitle generation module;
a text type of subtitle generation module having two input ends each connected with one of output ends of the de-muxer unit respectively, one of the two input ends receiving a sub-picture data stream to the subtitle decoding unit of the text type of subtitle generation module and the other one of the two input ends receiving a multinational subtitle control signal to the control unit of the text type of subtitle generation module, and the text type of subtitle generation module having a text subtitle displaying file register unit having an output end connected with a video subtitle composing unit;
the video decoding unit having an input end connected with the output end of the de-muxer unit, the video decoding unit decoding the video data stream received from the input end and then outputting the decoded video data to the video subtitle composing unit;
the audio decoding unit having an input end connected with the output end of the de-muxer unit, the audio decoding unit decoding the audio data stream received from the input end and then outputting the decoded audio signal to an audio output device;
the video subtitle composing unit connected with the video decoding unit and the text type of subtitle generation module, respectively, composing and linking the received video data and text subtitle displaying file and then transmitting to a video output device; and.
the video output device having an input end connected with the output end of the video subtitle composing unit.

2. The DVD player according to claim 1, wherein the de-muxer unit separates the digital data into a MPEG video data stream, a audio data stream and a sub-picture date stream; the MPEG video data stream being output to the video decoding unit; the audio data stream being output to the audio decoding unit; and the sub-picture data stream being output to the sub-picture decoding unit of the text type of the subtitle generation module.

3. The DVD player according to claim 1, wherein the text type of the subtitle generation module comprises:
a sub-picture decoding unit provided to receiving the multi-national sub-picture control signal from the output end of the de-muxer unit, and meanwhile outputting a multi-national picture type of subtitle to a character recognition transforming unit of the text type of subtitle generation module;
the character recognition transforming unit provided to receive the multi-national sub-picture control signal from the control unit, and to perform a character recognition transformation onto the multi-national picture type of subtitle sequentially to produce a text type of subtitle and subtitle displaying timecode, the so-produced subtitle and timecode then being transmitted to the text subtitle displaying file register unit;
the text subtitle displaying register unit receiving an enable signal from the signal control unit and then composing and storing the text type of subtitle and the subtitle displaying timecode from the character recognition transforming unit into a text subtitle displaying file, the file then being output to the vided subtitle composing unit; and
a signal control unit having an input end connected with the output end of the de-muxer unit, the signal control unit essentially receiving the multi-national sub-picture control signals from the user interface control unit and then transmitting the received signals to the sub-picture decoding unit, the character recognition transforming unit and the text subtitle displaying file register unit.
